(19) United States
(12) Patent Application Publication
(10) Pub. No.: US 2010/0011391 A1
(43) Pub. Date: Jan. 14, 2010

(54) Decoder-specific content provision system and method

(76) Inventors: Jason P. Carpenter, Seattle, WA (US); Aaron K. Warner, Seattle, WA (US); Jeffrey K. Thompson, Bothell, WA (US); Brandon Smith, Seattle, WA (US)

Correspondence Address: DTS, INC., 5220 Las Virgenes Road, Calabasas, CA, 91302, US

(21) Appl. No.: 12/218,313

(22) Filed: Jul. 14, 2008

(51) Int. Cl. H04N 7/16; H04N 7/173

(52) U.S. Cl. 725/25; 725/116

(57) ABSTRACT

A system for providing decoder-specific content is provided. The system includes a receiver list system receiving a receiver identifier and transmitting authentication data to a receiver. A receiver authentication system receives the authentication data and transmits content delivery data to a content server, such as data that authorizes the content server to provide content to the receiver. A receiver update system transmits update data to the receiver, such as a list of available channels of content.

### FIELD OF THE INVENTION

The present invention relates to systems and methods for providing audio and video content, and more particularly to a decoder-specific content provision system and method of operation.

### BACKGROUND OF THE INVENTION

Systems and method for providing audio and video content over a communications medium are known in the art. Such systems allow users to obtain content, such as audio data, over a communications medium, such as the Internet, but do not allow the user to determine the format of such content. As a result, users often receive content of poor quality, a problem that is exacerbated by the growing number of content providers that are providing such content.

### SUMMARY OF THE INVENTION

Therefore, a decoder-specific content provision system and method are provided that allow receivers to automatically register with a decoder-specific content service.

In particular, a decoder-specific content provision system and method are provided that allow a user to configure a receiver to receive decoder-specific content of interest to the user.

In accordance with an exemplary embodiment of the invention, a system for providing decoder-specific content is provided. The system includes a receiver list system receiving a receiver identifier and transmitting authentication data to a receiver. A receiver authentication system receives the authentication data and transmits content delivery data to a content server, such as data that authorizes the content server to provide content to the receiver. A receiver update system transmits update data to the receiver, such as a list of available channels of content.

The present invention provides many important technical advantages. One important technical advantage of the present invention is a system that allows a receiver purchaser, such as someone that purchases a receiver with a Neural Audio Surround™ decoder or other suitable decoders, to automatically be directed to predetermined sources of content from a plurality of content sources that provide content that has been encoded with a Neural Audio Surround™ encoder or other suitable encoders. In this manner, receiver purchasers do not have to try and locate suitable content sources from literally thousands of potential content sources, but can be directed to qualified content sources.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for providing decoder-specific formatted content in accordance with an exemplary embodiment of the present invention;

FIG. 2 is a diagram of a system for providing identity server processing in accordance with an exemplary embodiment of the present invention;

FIG. 3 is a diagram of a system for providing content server functionality in accordance with exemplary embodiment of the present invention;

FIG. 4 is a diagram of a system for an audio receiver in accordance with an exemplary embodiment invention;

FIG. 5 is a flow chart of a method for authenticating a receiver in accordance with an exemplary embodiment of present invention;

FIG. 6 is a flowchart of a method for providing a receiver with decoder specific content in accordance with an exemplary embodiment of the present invention; and

FIG. 7 is a flow chart of a method for locating a receiver in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures may not be to scale and certain components may be shown in generalized or schematic form and identified by commercial designations in the interest of clarity and conciseness.

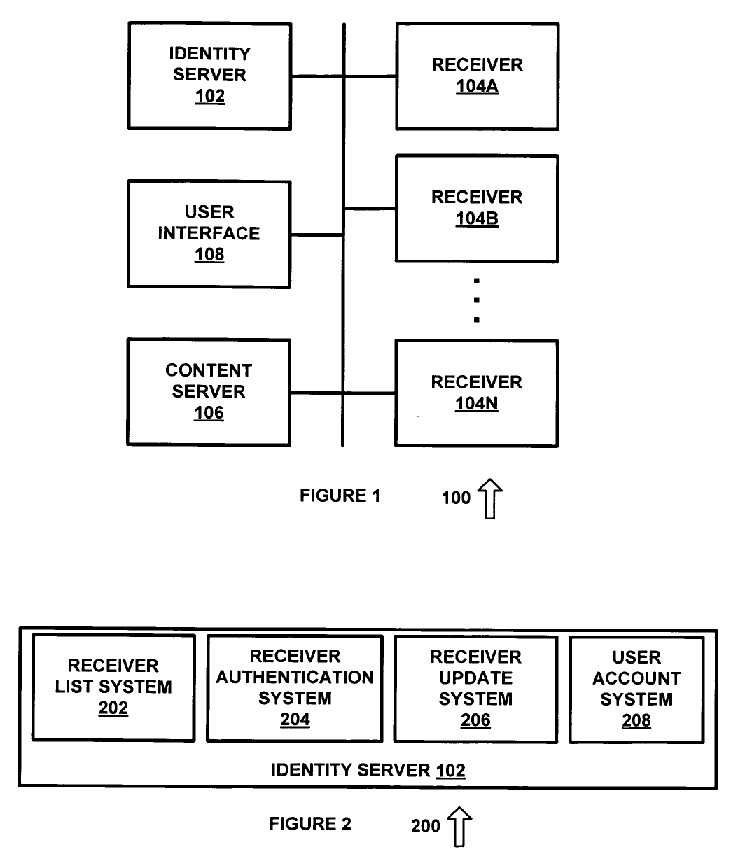

FIG. 1 is a diagram of a system 100 for providing decoder-specific formatted content in accordance with an exemplary embodiment of the present invention. System 100 allows receivers having a customized decoder to receive content specific to that decoder from a content server, so as to ensure that the receivers are provided with a source for quality content that has been encoded so as to provide optimal quality for the decoder at the receiver.

System 100 includes identity server 102, receivers 104A through 104N, content server 106, and user interface 108. Identity server 102 can be implemented in hardware, software, or a suitable combination of hardware and software, and can be one or more software systems operating on a general purpose server platform. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Identity server 102 stores identity data for a plurality of receivers, so as to allow the receivers to contact identity server 102 and receive tokens or other credentials to allow the receivers to contact a content server and to receive content from the content server. Likewise, identity server 102 allows users of the receivers to configure the receivers in accordance with user specific selections.

Receivers 104A through 104N are audio receivers that receive and process audio data. In one exemplary embodiment, receivers 104A through 104N can be multimedia receivers that are used in conjunction with televisions, DVD players, CD players, MP3 players, broadcast audio data, audio data receiver over a communications medium such as the Internet, or other suitable audio data. Receivers 104A through 104N can include receiver-specific decoders, such as a Neural Surround™ codec available from Neural Audio of Kirkland Wash., a Cirrus Logic codec, a Windows Media codec, a Dolby codec, or other suitable codecs.

Content server 106 can be implemented in hardware, software, or a suitable combination of hardware and software, and can be one or more software systems operating on a general purpose server platform. In one exemplary embodiment, content server 106 stores one or more programs of audio content, content on demand, or other suitable content. In this exemplary embodiment, content server 106 can allow a user of receivers 104A through 104N to select one or more channels of audio programming, individual audio programs or recordings or other suitable audio data.

User interface 108 allows a user of a receiver 104A through 104N to configure an account so as to provide additional functionality beyond that which can be directly supported by receivers 104A through 104N without an additional user interface. In one exemplary embodiment, user interface 108 can be implemented as a web browser accessible website that includes a number of user-selectable controls that allows the user to configure the receiver associated with the user, the content that is to be provided to the receiver, or other suitable information.

In operation, system 100 allows content that has been encoded for a specific decoder on a receiver to be provided to users who purchase the receiver, such as part of an incentive to purchase a receiver. In one exemplary embodiment, a user purchasing a receiver 104A through 104N connects the receiver to a communications medium such as the Internet. When the receiver is connected to the communications medium and powered up, systems operating on the receiver can transmit information to identity server 102 such as a receiver serial number and other suitable information. Identity server 102 can verify the identity of the receiver, such as by comparing the receiver identification against a list of approved receivers or in other suitable manners, and can transmit a token or other suitable data to the receiver at the address provided by the receiver. In this exemplary embodiment, the token can be provided with a time characteristic such that tokens provided by identity server 102 are only valid for a short period of time. The requesting receiver 104A through 104N then receives the token and associated information, such as an address of content server 106, a decoder type, or other suitable data and transmits the token to content server 106. Content server 106 then transmits the receiver identification, the token, or other suitable information to identity server 102, and upon authorization from identity server 102, provides content to the requesting receiver 104A through 104N in an encoded format that is optimized for the decoder associated with that receiver.

A user can also receive information such as a receiver identification number to allow the user to access identity server 102 or content server 106 using user interface 108. In one exemplary embodiment, a user logs on to a user account system by entering a receiver number or other suitable information such as a user account number and password, and can then configure the content to be provided to receiver associated with the user account, the user controls to be provided to the receiver, or other suitable data.

FIG. 2 is a diagram of a system 200 for providing identity server processing in accordance with an exemplary embodiment of the present invention. System 200 includes identity server 102 and receiver list system 202, receiver authentication system 204, receiver update system 206, and user account system 208, each of which can be implemented in hardware, software, or a suitable combination of hardware and software, and which can be one or more software systems operating on a general purpose processing platform.

Receiver list system 202 includes a list of receivers that are authorized to receive receiver-specific content. In one exemplary embodiment, receiver list system 202 can receive a list of receiver serial numbers at the time the receivers are shipped for delivery to consumers, can be updated with receiver serial numbers such as by allowing a user to enter a receiver serial number and performing pre-determined verification procedures on the receiver serial number, or can otherwise verify the identity of receivers. Receiver list system 202 can transmit a token, the address of a content server, and other suitable data to a receiver.

Receiver authentication system 204 receives receiver identification data from receiver list system 202 and performs receiver authentication. In one exemplary embodiment, receiver authentication system 204 can receive a token (or other data providing the same function as a token) and other suitable data from content server 106 or other suitable systems, and can transmit receiver authentication data to content server 106 or other suitable systems so as to allow content server 106 to transmit content to the receiver. Likewise, receiver authentication system 204 can receive periodic requests for authentication from a receiver through content server 106 or other suitable systems, such as after a time period associated with a first token that was transmitted to the receiver has expired and a second or subsequent token has been transmitted to the receiver by receiver list system 202.

Receiver update system 206 receives update request data and transmits update data to receivers. In one exemplary embodiment, receiver updates can be periodically broadcast to receivers, such as to provide program listings, receiver functionality, codec updates, or other suitable data. Likewise, receiver updates can be automatically requested by the receiver, can be requested an operator of a receiver, such as by transmitting an update request command over a communications medium to an identity server, by requesting a receiver update from a user interface, or in other suitable manners.

User account system 208 allows the user to access functionality on identity server 102, content server 106 or other suitable systems, such as to allow the user to configure program listings or station listings on a receiver, to select content on demand, to select programming, or for other suitable purposes. In one exemplary embodiment, user account system 208 allows a user to request additional programming content, such as programming content that has not been encoded for the decoders associated with the receiver, or to perform other suitable functions.

In operation, system 200 provides identity functions for a system for providing decoder specific content for a receiver. System 200 allows receivers to authenticate or be authenticated automatically upon connection to a communications medium, allows the receivers to be updated to provide additional data and functionality that was not present on the receiver when it was initially shipped, allows users to set up accounts, and allows other suitable functions to be performed.

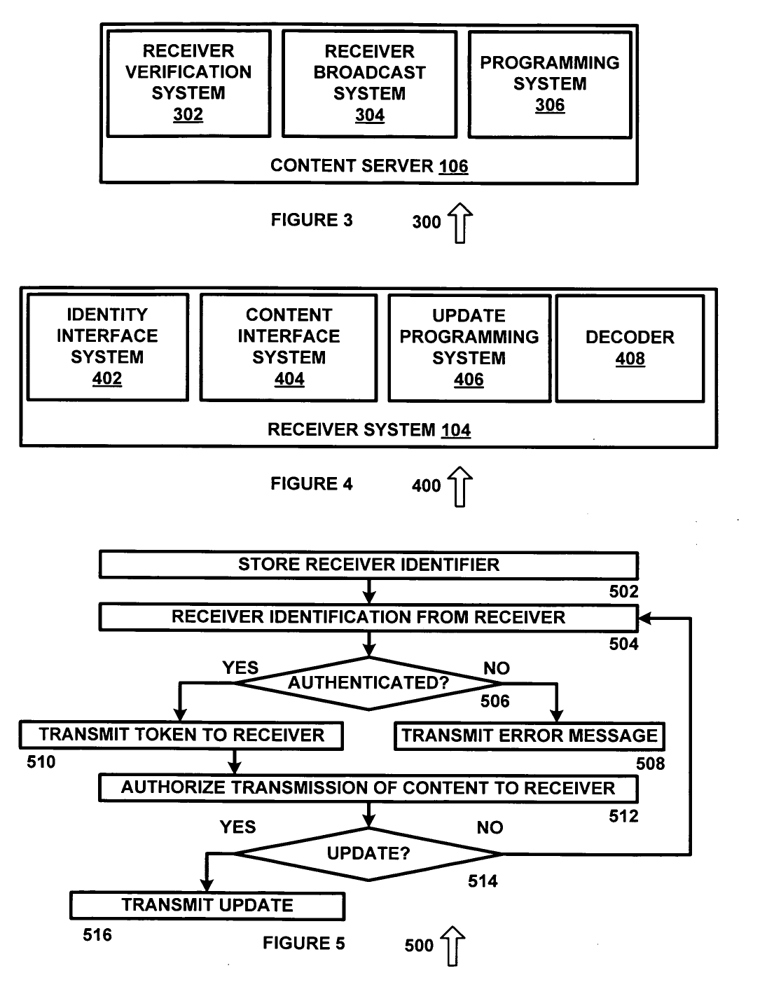

FIG. 3 is a diagram of a system 300 for providing content server functionality in accordance with an exemplary embodiment of the present invention. System 300 includes content server 106 and receiver verification system 302, receiver broadcast system 304, and programming system 306, each of which can be implemented in hardware, software or a suitable combination of hardware and software, and which can be one or more software systems operating on a general purpose processing platform.

Receiver verification system 302 receives token data, address data, receiver identification data or other suitable data from a receiver and transmits the data to an identification server or other suitable systems. In one exemplary embodiment, receiver verification system 302 receives a confirmation from the identity server or other suitable systems that the receiver is authorized to receive content.

In addition, verification system 302 can be used to determine the location of the receiver within a range of the nearest network router (also referred to as the “closest hop”), as well as information identifying the owner of the IP address. Verification system 302 can locate a receiver using this data, such as within 25 miles to 90% accuracy, within 15 miles to 85% accuracy, within 5 miles to 70% accuracy, or within other levels of accuracy based on the particular Internet service provider utilized by the receiver.

In one exemplary embodiment, the IP address geo-location data can be combined with an online or offline router hop detection system to increase location accuracy. Geo-location data can be obtained from a list of available IP addresses that is correlated to the IP address owner's information. Router hop detection can be used to determine the physical location of the closest IP router to the device, which can reveal the organization that the device is using to connect to the network, but this can take a significant amount of time, such as up to 20 minutes, to determine the closest IP router. By combining the geo-location with router hop detection using a off-line weighted value system of data received from each technique, the geographic location accuracy can be as good as the building the device is located in, which can allow the location information to be used for selecting geographically-relevant advertising or programming data, detection and location of stolen devices, or for other suitable purposes.

Receiver broadcast system 304 broadcasts content to receivers. In one exemplary embodiment, each receiver receiving content can have the content sent to them directly, receivers can be configured to access a broadcast content stream, or other suitable content broadcast processes can be utilized. Content can be selected based on a receiver type, a codec type, a user-entered content type, or other suitable data.

Programming system 306 receives programming from identity server 102 or other suitable sources. In one exemplary embodiment, programming system 306 can store programming that has been provided previously, can update programming to provide additional programs, content or libraries of content, can receive user selections so as to provide user specific programming, or can provide other suitable data.

In operation, system 300 allows a content server to provide receiver specific content that has been optimized for a decoder of a receiver. System 300 can also limit provision of content to receivers that are authorized to receive such content, so as to avoid provision of content to parties that have not purchased a receiver, can provide receiver or user specific programming, and can provide other suitable functions.

FIG. 4 is a diagram of a system 400 for an audio receiver in accordance with an exemplary embodiment invention. System 400 includes receiver 104 and identity interface system 402, content interface system 404, update programming system 406 and decoder system 408, each of which can be implemented in hardware, software, or a suitable combination of hardware and software, and which can be one or more software systems operating on a receiver having a specific decoder or set of decoders.

Identity interface system 402 allows a receiver to interface with an identity server or other suitable identity verification systems. In one exemplary embodiment, identity interface system 402 tests for the availability of a communications medium, and transmits an identification request to a predetermined address upon detection of a communications medium so as to receive a confirmation of identification or authorization. Likewise, identity interface system 402 can search for an identification server or other suitable sources if the pre-stored identification server is no longer available.

Content interface system 404 interfaces with a content server to transmit a token, a request for programming, user programming selections, and other suitable data, and to receive content. In one exemplary embodiment, content interface system 404 can receive token data from identity interface system 402 and transmit the token data to a content server at a predetermined URL, a URL that is transmitted from the identity server, at other suitable addresses or in other suitable manners. Content interface system 404 can also request one or more channels of programming from a content server, can provide identification data that is required to receive codec-specific programming, can provide a request for user selected programming, or can perform other suitable functionality.

Update programming system 406 receives update data, programming, or other suitable data from an identity server or content server and applies the update data, programming or other data at the receiver. In one exemplary embodiment, a receiver can include a list of sources for audio content, such as an Internet radio station guide or other suitable content selection mechanisms. Likewise, the decoder or other receiver functionality can be implemented partially or completely in software, such that update programming system 406 can receive and implement updates to decoder software or other receiver software. Update programming system 406 can also generate a request for a programming update, such as to periodically request updating so as to ensure that the programming in the receiver remains up to date.

Decoder system 408 can include one or more decoders, such as decoders compatible with a Neural Surround™ codec available from Neural Audio of Kirkland Wash., a Cirrus Logic codec, a Windows Media codec, a Dolby codec, or other suitable codecs. Decoder system 408 can include associated content server addresses such as URLs, and can allow a user to select one of a plurality of decoders. In one exemplary embodiment, decoder system 408 can have a default decoder setting associated with an identity server and a content server, such as where the default decoder setting allows the receiver to be configured to receive content from a predetermined content server upon initial start-up.

In operation, system 400 allows a receiver having a decoder that implements a proprietary or specific codec design to receive content that is encoded specifically for that decoder, so as to provide full utilization of receiver specific content playing abilities.

FIG. 5 is a flow chart of a method 500 for authenticating a receiver in accordance with an exemplary embodiment of present invention. Method 500 begins at 502, where a receiver identifier such as a unit identification number is stored. In one exemplary embodiment, the receiver identifier can be received from a manufacturer in a list of receivers prior to shipment of the receivers, can be received from a user that enters a receiver identifier that is then verified using a verification algorithm or other suitable processes, or can be received in other suitable manners. The method then proceeds to 504.

At 504, a receiver identifier is received from the receiver. In one exemplary embodiment, when a receiver is powered up and connected to a communication medium for the first time, the receiver can transmit a receiver identifier to a predetermined URL or other location. The method then proceeds to 506.

At 506, it is determined whether the receiver identification has been authenticated. If the receiver identification has not been authenticated, the method proceeds to 508 where an error message is transmitted to the receiver. Likewise, the user can be instructed to authenticate the receiver using a different process, the receiver can be interrogated for additional identification data, or other suitable processes can also or alternatively be used. If receiver identification has been authenticated, the method proceeds to 510 where a token (or other suitable data having the same function as a token) is transmitted to the receiver in addition to other associated data such as URL address for a content server or other suitable data. In one exemplary embodiment, additional authentication processes can be omitted and content can be transmitted to the receiver. The method then proceeds to 512.

At 512 transmission of content to the receiver is authorized. In one exemplary embodiment, a token can be received from a content server, such as the token that was previously transmitted to the receiver, a token that is generated in response to receipt of the token from the receiver, or other suitable data providing the same function as a token. In another exemplary embodiment, it can be determined whether the token has been received from the receiver within a predetermined time period, such as where content is transmitted to the receiver as long as the receiver continues to transmit the token back to the content server. Additional processes can also or alternatively be used, such as where the token is periodically updated, where content is transmitted from the identity server, or where other suitable processes are performed. The method then proceeds to 514 where it is determined whether an update is required for the receiver. If it is determined that an update is not required, the method returns to 504 where identification is received from the receiver, such as in a process where tokens are continuously transmitted so as to ensure that the receiver remains continuously authenticated. Likewise, the method can terminate where continuous authentication is not performed, or other suitable processes can be performed. If it is determined at 514 that an update is required, such as based on software version data or other suitable data received from the receiver, the method proceeds to 516 where an update is transmitted to the receiver, such as a codec software update, program selection software update, content source listing data, or other suitable updates.

In operation, method 500 allows a receiver having a customized codec to be authenticated and to receive content that is encoded using a process that is optimized for the codec. In this manner, a user of the receiver can receive content from a source that provides content having predetermined characteristics, such that the user does not need to manually sort through a large number of potential sources to find properly encoded content.

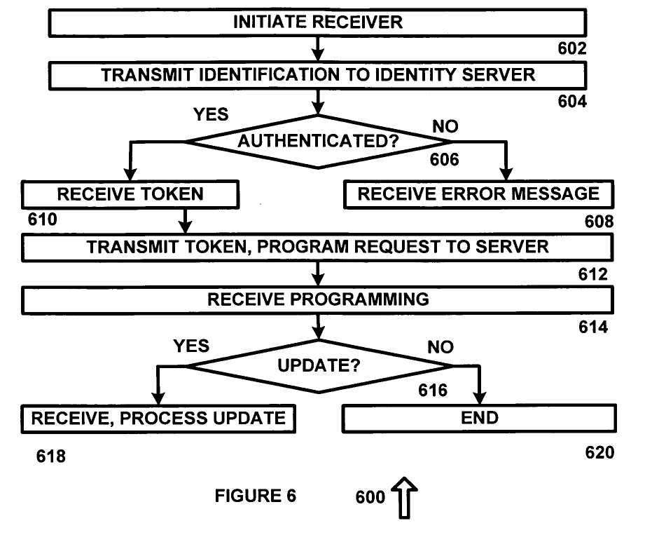

FIG. 6 is a flowchart of a method 600 for providing a receiver with decoder specific content in accordance with an exemplary embodiment of the present invention. Method 600 begins at 602 where a receiver is initiated, such as by powering the receiver on. The method then proceeds to 604 where identification data is transmitted to an identity server by the receiver. In one exemplary embodiment, the receiver can monitor for or detect the availability of a communications medium such as an Internet communications medium, a wireless communications medium, a wire line communications medium or other suitable media, and can transmit the identification data to an identity server or other suitable systems at a predetermined URL, can search for a URL for the identity server using a web browser or other suitable systems, or can perform other suitable functions. The method then proceeds to 606.

At 606 it is determined whether the receiver has been authenticated. If the receiver has not been authenticated, the method proceeds to 608 where an error message is received, such as instructing the user on how to request or retry authentication. Otherwise the method proceeds to 610 where a token or other suitable data is received. The method then proceeds to 612 where the token, programming request or other suitable data is transmitted to a server. In one exemplary embodiment, the token can be valid for a predetermined length of time so as to require periodic transmission of tokens for continued reception of content. The content request can be a default content request, a user selected content request or other suitable content requests. The token, content request and other suitable data can be transmitted to a content server, an identity server (such as where the content and identity server are the same), or other suitable servers. The method then proceeds to 614.

At 614, programming is received at the receiver. In one exemplary embodiment, the programming can be configured to provide optimal quality for a specific decoder of the receiver. In another exemplary embodiment, the receiver can have a decoder that is optimized for content that has been encoded using a predetermined encoding process, and can receive programming that is optimized for the associated decoder. The method then proceeds to 616.

At 616 it is determined whether an update for the receiver is required, has been requested, has been received, or is otherwise available. If no update is required, the method proceeds to 620 and terminates. Otherwise the method proceeds to 618 where an update is requested, received and processed, such as by updating a software program, a list of content sources, or other suitable data.

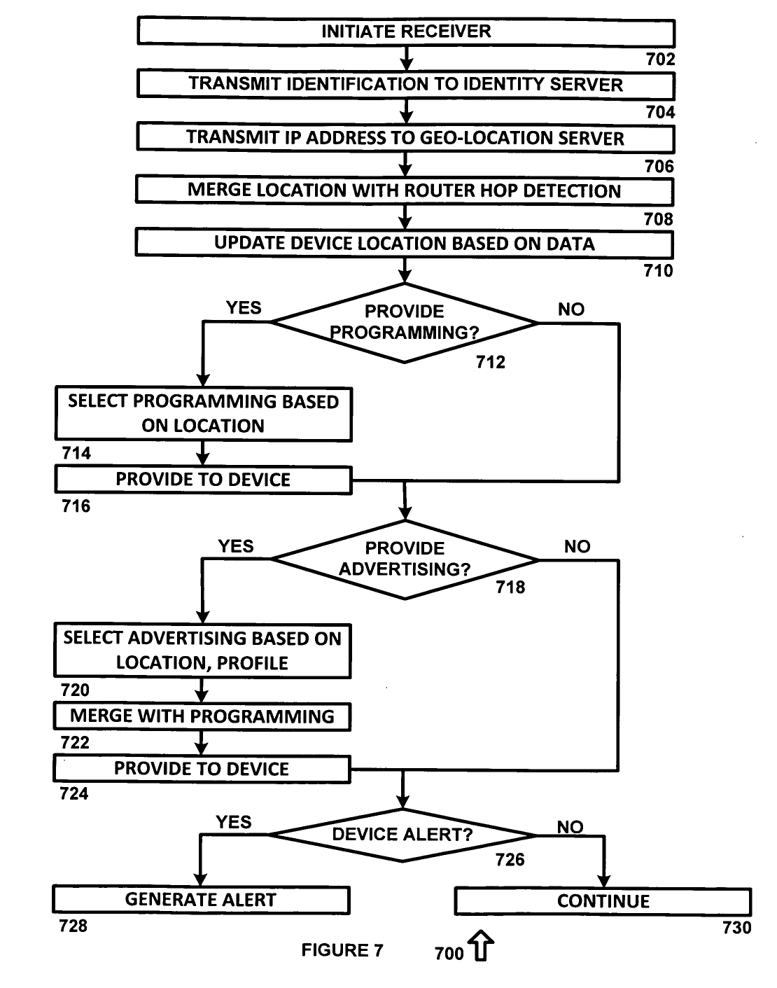

FIG. 7 is a flow chart of a method 700 for locating a receiver in accordance with an exemplary embodiment of the present invention. Method 700 begins at 702 where a receiver is initiated, such as by performing receiver initialization in response to detection of a new IP address, as part of receiver start-up, or in other suitable manners. The method then proceeds to 704.

At 704, identification of the receiver is provided to an identity server, such as by transmitting a unique receiver identifier and IP address to a predetermined IP address, in response to a request for receiver identification from the identity server, or in other suitable manners. The method then proceeds to 706.

At 706, an IP address of the receiver is provided to a geo-location server in order to obtain geographical location data associated with the IP address. The IP address associated with a receiver can provide geographic location data that is relatively accurate, but depending on the Internet service provider and account type, the geographic location data might be accurate only to within 25 or more miles. The method then proceeds to 708.

At 708, the geographic location data is merged with router hop data, such as data that identifies a geographic location of the last router to transmit IP packets to the receiver. In one exemplary embodiment, the geographic location data for the router can take precedence over the geographic location data for the IP address, the approximate location can be estimated based on the geographic location data for the router and the geographic location data for the IP address, or the geographic location data for the IP address can be used, such as where the geographic location data for the router can not be determined. The method then proceeds to 710.

At 710, location data associated with the device is updated, such as by associating the device geographic location with device identification data, by comparing the new device geographic location data to previously stored geographic location data, or in other suitable manners. The method then proceeds to 712.

At 712, it is determined whether programming should be provided to the device. In one exemplary embodiment, programming can be provided in response to a request for programming. Likewise, if it is determined that the geographic location of a device has changed, a request for programming data can be ignored pending additional information, or other suitable processes can be used. If it is determined that programming should not be provided to the device, the methods proceeds to 718. Otherwise, the method proceeds to 714.

At 714, programming is selected based on location. In one exemplary embodiment, location-specific content can be selected, such as sound recordings by local musicians, sound recordings for musicians that will be performing within a predetermined time period in a venue in the geographic location of the receiver, information pertaining to news, attractions or activities for a location can be selected, or other suitable location based programming can be selected. The method then proceeds to 716, where the programming is provided to the device. The method then proceeds to 718.

At 718, it is determined whether advertising should be provided. If it is determined that advertising should not be provided, such as where a subscriber has paid for programming to be provided without advertising, the method proceeds to 726. Otherwise, the method proceeds to 720.

At 720, advertising is selected, such as based on the geographic location data, user profile data associated with the device or a selected programming channel, or other suitable data. In one exemplary embodiment, advertising can be selected for advertisers in the same geographic location as the receiver geographic location. Advertising can also be provided based on the user profile, such as to provide geographically relevant advertising of potential interest to the user based on data in the user profile that identifies where the user shops, the user's interests, or other suitable data. Advertising can also be selected based on the geographic location data and the programming content, such as where the programming relates to local musicians and the advertising relates to venues where those local musicians will be performing. Other suitable selection processes can also or alternatively be performed. The method then proceeds to 722.

At 722, the advertising is merged with the programming. In one exemplary embodiment, one or more data filters can be applied, such as to prevent inappropriate advertising from being provided based on the preceding content. In this exemplary embodiment, data identifying a musical composition or programming channel that has a predetermined target audience, such as young children, would be used to filter advertising relating to subjects inappropriate for young children. Other suitable processes can also or alternatively be used. The method then proceeds to 724 where the merged advertising and programming content is provided to the receiver. The method then proceeds to 726.

At 726, it is determined whether a device alert should be generated. In one exemplary embodiment, if a receiver has been reported stolen, the receiver identifier can be stored and receivers having new geographic location data can be checked against the stored data to determine whether additional action is required. If it is determined that no device alert is required, the method proceeds to 730 and regular programming continues. Otherwise, the method proceeds to 728, where an alert is generated. In one exemplary embodiment, the alert can notify authorities of the location of the receiver, can request address data from the Internet services provider, or other suitable processes can be performed. In another exemplary embodiment, the user can be asked to enter a predetermined identification code into the receiver, to contact a representative or to take other suitable actions. The receiver can also or alternatively be disabled until the status of the receiver is updated.

In operation, method 700 allows geographic location data for a receiver or other devices to be determined and used to select programming, advertising, to locate stolen devices, or for other suitable purposes.

In view of the above detailed description of the present invention and associated drawings, other modifications and variations are apparent to those skilled in the art. It is also apparent that such other modifications and variations may be effected without departing from the spirit and scope of the present invention.

What is claimed is:

1. A system for providing decoder-specific content comprising:
a receiver list system receiving a receiver identifier and transmitting authentication data to a receiver;
a receiver authentication system receiving the authentication data and transmitting content delivery data to a content server; and
a receiver update system transmitting update data to the receiver.

2. The system of claim 1 further comprising a user account system receiving user identification data associated with the receiver identifier and creating a user account associated with the receiver.

3. The system of claim 1 wherein the receiver list system determines a codec type associated with the receiver identifier and transmits authentication data to the receiver and address data for a content server associated with the codec type.

4. The system of claim 1 wherein the receiver update system transmits content source update data to the receiver.

5. The system of claim 1 further comprising a user account system receiving user account data and associating the user account data with the receiver.

6. The system of claim 1 wherein the receiver list system receives a plurality of receiver identifiers from a manufacturer and transmits the authentication data to the receiver if the receiver identifier is present in the plurality of receiver identifiers received from the manufacturer.

7. The system of claim 1 further comprising a receiver transmitting the receiver identifier to the receiver list system, receiving the authentication data and transmitting the authentication data to the content server.

8. A method for delivering decoder-specific content comprising:
receiving a receiver identifier;
determining that a receiver is associated with the receiver identifier;
transmitting authorization data to the receiver;
receiving the authorization data from a content server; and
transmitting content delivery authorization to the content server.

9. The method of claim 8 further comprising:
receiving a plurality of receiver identifiers from a manufacturer; and
wherein determining that the receiver is associated with the receiver identifier comprises determining that the receiver identifier is in the plurality of receiver identifiers from the manufacturer.

10. The method of claim 8 further comprising transmitting update data to the receiver.

11. The method of claim 8 further comprising:
receiving user account data; and
associating the user account data with the receiver.

12. The method of claim 8 further comprising transmitting content to the content server, wherein the content is encoded using an encoder associated with the receiver.

13. A system for providing decoder-specific content comprising:
an identity interface system transmitting a receiver identifier to an identity system and receiving authentication data;
a content interface system transmitting the authentication data to a content system; and
a decoder system receiving content from the content system and decoding the content using one of a plurality of decoders, wherein the decoder is associated with an encoder of the content.

14. The system of claim 13 further comprising a user interface receiving receiver control data and transmitting one or more user selections to a user account system.

15. The system of claim 13 wherein the identity interface system, the content interface system and the decoder system are each contained within a receiver housing.

16. The system of claim 15 further comprising a user interface external to the receiver housing receiving receiver control data and transmitting one or more user selections to a user account system.

17. The system of claim 15 wherein the authentication data comprises a token and token expiration data.

18. The system of claim 15 wherein the authentication data comprises an address of the content system.

19. The system of claim 15 further comprising an update programming system receiving programming data and updating programming data provided with a receiver.

20. The system of claim 19 wherein the identity interface system, the content interface system, the decoder system and the update programming system are each contained within a receiver housing.
